(19) United States
(12) Patent Application Publication
(10) Pub. No.: US 2021/0396912 A1
(43) Pub. Date: Dec. 23, 2021

(54) OPTICAL FILM LAYER AND DISPLAY DEVICE

(71) Applicant: TPK Advanced Solutions Inc., Xiamen (CN)

(72) Inventors: Jianbin Yan, Putian City (CN); Yiduan Zhou, Pinghe County (CN); Shunlong Lin, Zhangzhou City (CN)

(21) Appl. No.: 17/079,801

(22) Filed: Oct. 26, 2020

(30) Foreign Application Priority Data
Jun. 23, 2020 (CN) 202010582802.3

(51) Int. Cl. G02B 1/111; G06F 1/16

(52) U.S. Cl. CPC G02B 1/111; G02B 2207/109; G06F 1/1609

(57) ABSTRACT

The present disclosure provides an optical film layer including a first transparent cover layer, a second transparent cover layer, an ink layer, and a connection layer. The second transparent cover layer is disposed over the first transparent cover layer. The ink layer is disposed on an edge region of a surface of the second transparent cover layer. The connection layer is disposed between the ink layer and the first transparent cover layer and between the surface of the second transparent cover layer and the first transparent cover layer to connect the first transparent cover layer and the second transparent cover layer. By disposing the ink layer between the first transparent cover layer and the second transparent cover layer, a problem of light leaking from an edge of a view area is solved and a display device is thinned, thereby enhancing a display quality of the display device.

### RELATED APPLICATIONS

This application claims priority to China Application Serial Number 202010582802.3, filed Jun. 23, 2020, which is herein incorporated by reference.

### BACKGROUND

### Field of Disclosure

The present disclosure relates to a display technique, and more particularly, to an optical film layer and a display device.

### Description of Related Art

Cover layers of display screens of portable electronic products in the current market are typically made from multi-layered plastic composite materials, which increase impact resistance of the cover layer of the screen, enhance product reliability, and reduce cost. An area of a bottom surface of the cover layer of the display screen corresponding to a border area outside of a view area of a display screen is usually printed with an ink layer to hide the underlying devices or structures.

A black ink is beneficial to shade light from an underlying display module. As such, an ink layer printed on an edge area of the cover layer of the display screen is generally black to form the display screen having a black border. As designs of portable electronic devices are diversified, the electronic devices have various border colors. However, shading effects of inks of other colors are not as good as that of a black ink. As such, when a cover layer having a non-black edge area is formed, in addition to an ink with a desired border color, a black ink or a gray ink is further printed thereon. For example, when a cover layer with a white edge area is formed, a white ink layer is firstly printed on the edge area of the bottom surface of the cover layer, and a black ink layer or a gray ink layer is then printed on the white ink layer to certainly shade light emitted toward the edge area by the display module.

When at least two ink layers are printed, the inks are closer to the underlying light source and an angle at which a user can see the light emitted toward the edge of the view area from a top of the cover layer is larger, thus resulting in an edge glow problem. In addition, when the ink layer is printed on the edge area the bottom surface of the cover layer, the edge area of the bottom surface of the cover layer and the view area of the bottom surface of the cover layer have a level difference due to the ink layer. Therefore, the level difference caused by the ink needs to be overcome during manufacturing, which slows down production. In order to overcome the level difference caused by the ink, a thicker solid optical clear adhesive is usually adopted, thus resulting in a thickness of the electronic device being increased and cost being increased.

### SUMMARY

In order to solve the problem of light leaking from the edge of the view area and overcome the insufficiency of the current techniques, one objective of the present disclosure is to provide an optical film layer and a display device, which can effectively solve the problem of light leaking from the edge of the view area, thereby enhancing display quality of the display device.

Another objective of the present disclosure is to provide an optical film layer and a display device, in which a level difference problem that occurs when the two transparent cover layers are connected is solved by using a connection layer, thereby enabling a border area of the display device to have multiple color choices, the display device to be further thinned, production costs to be decreased, and units per hour per person (UPPH) increased.

Technical schemes of the present disclosure are as follows.

An optical film layer includes a first transparent cover layer, a second transparent cover layer, an ink layer, and a connection layer. The second transparent cover layer is disposed over the first transparent cover layer. The ink layer is disposed on an edge region of a surface of the second transparent cover layer. The connection layer is disposed between the ink layer and the first transparent cover layer and between the surface of the second transparent cover layer and the first transparent cover layer to connect the first transparent cover layer and the second transparent cover layer.

In some embodiments, the first transparent cover layer includes a polycarbonate (PC) layer.

In some embodiments, the second transparent cover layer includes an anti-glare (AG) layer or a polymethyl methacrylate (PMMA) layer.

In some embodiments, the second transparent cover layer is an ultraviolet cutoff (UV-cut) layer.

In some embodiments, the ink layer includes a first ink layer and a second ink layer. The first ink layer is disposed on the surface of the second transparent cover layer. The second ink layer is disposed between the first ink layer and the connection layer, in which the second ink layer and the first ink layer have different colors.

In some embodiments, the connection layer includes a water gel or a solid optical clear adhesive (OCA).

A display device includes an optical film layer and a display module. The optical film layer includes a first transparent cover layer, a second transparent cover layer, an ink layer, and a connection layer. The second transparent cover layer is disposed over the first transparent cover layer. The ink layer is disposed on an edge region of a surface of the second transparent cover layer. The connection layer is disposed between the ink layer and the first transparent cover layer and between the surface of the second transparent cover layer and the first transparent cover layer to connect the first transparent cover layer and the second transparent cover layer. The display module is disposed under the optical film layer.

In some embodiments, the display module includes a display panel and a light source module. The light source module is disposed at one side of the display panel and is configured to provide the display panel with light.

In some embodiments, the light source module is located between the display panel and the optical film layer.

In some embodiments, the display device further includes a touch sensor module located between the light source module and the optical film layer.

In some embodiments, the first transparent cover layer includes a polycarbonate layer, and the second transparent cover layer includes an anti-glare layer or a polymethyl methacrylate layer.

In some embodiments, the second transparent cover layer is an ultraviolet cutoff (UV-cut) layer.

In some embodiments, the ink layer includes a first ink layer and a second ink layer. The first ink layer is disposed on the surface of the second transparent cover layer. The second ink layer is disposed between the first ink layer and the connection layer, in which the second ink layer and the first ink layer have different colors.

In some embodiments, the connection layer includes a water gel or a solid optical clear adhesive.

The technical schemes of the present disclosure put the ink layer between the two transparent cover layers, such that light emitted toward an edge of a view area is firstly absorbed and refracted by the lower transparent cover layer and the connection layer and is shaded by the ink layer before entering the upper transparent cover layer. In addition, the ink layer is closer to a light-extracting surface of the optical film layer, such that the ink layer can shade the light emitted toward the edge of the view area more effectively, and an angle at which a user can see the light emitted toward the edge of the view area from a top of the cover layer can be greatly reduced, thereby solving the problem of light leaking from the edge of the view area and enhancing an optical property and a displaying effect of the display device. Furthermore, a softer and thinner film with a UV resistant and anti-glare property may be used as the upper transparent cover layer, such that a level difference between the view area and an edge area caused by the ink layer can be easily overcome, an overall thickness of the optical film layer can be reduced, production costs can be decreased, and units per hour per person can be increased. The problem of light leaking from the edge of the view area is solved without increasing the thickness of the optical film layer, so the ink layer with a desired color can be applied on an edge area according to a product design.

### BRIEF DESCRIPTION OF THE DRAWINGS

Aspects of the present disclosure are better understood from the following detailed description in conjunction with the accompanying figures. It is noted that in accordance with the standard practice in the industry, various features are not drawn to scale. In fact, the dimensions of the various features can be arbitrarily increased or reduced for clarity of discussion.

FIG. 1 is a schematic cross-sectional view of an optical film layer in accordance with some embodiments of the present disclosure.

FIG. 2 is a schematic cross-sectional view of a partial enlargement of an optical film layer in accordance with some embodiments of the present disclosure.

FIG. 3 is a schematic diagram of a display device in accordance with some embodiments of the present disclosure.

FIG. 4 is a schematic diagram of a display device in accordance with some embodiments of the present disclosure.

FIG. 5 is a schematic diagram of a display device in accordance with some embodiments of the present disclosure.

FIG. 6 is a schematic diagram of a display device in accordance with some embodiments of the present disclosure.

### DETAILED DESCRIPTION

In order to make the objectives, technique schemes, and advantages of the present disclosure become better understood, the disclosure is described in detail below with reference made to the accompanying drawings, embodiments, and examples. It is to be appreciated that the specific embodiments and examples described herein are used to explain the present disclosure only and are not intended to limit the scope of the claims.

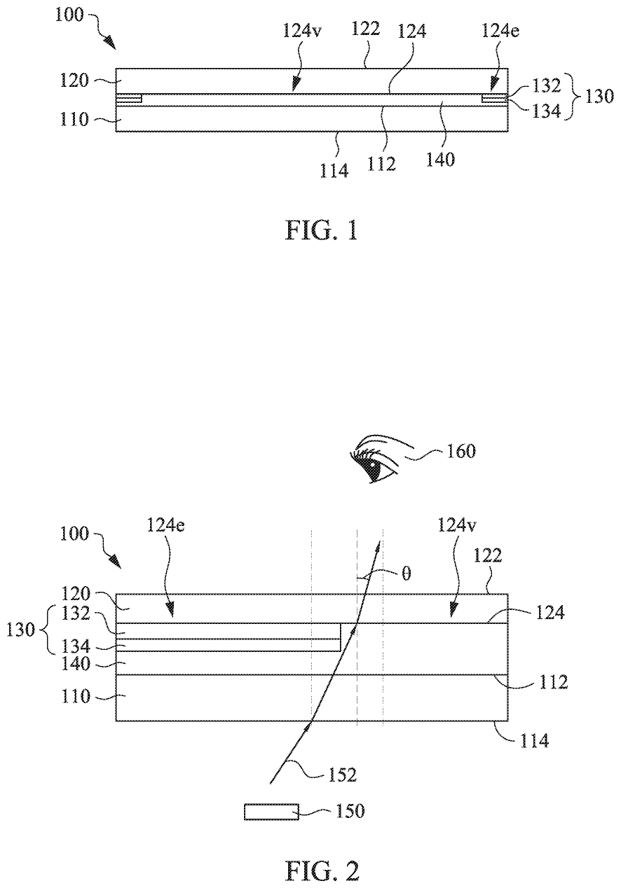

Referring to FIG. 1, FIG. 1 is a schematic cross-sectional view of an optical film layer 100 in accordance with some embodiments of the present disclosure. The optical film layer 100 includes a first transparent cover layer 110, a second transparent cover layer 120, an ink layer 130, and a connection layer 140. The first transparent cover layer 110 is a plane that is pervious to light and has certain structure ductility. The first transparent cover layer 110 has surfaces 112 and 114, which are opposite to each other. The first transparent cover layer 110 may be an optical function layer, such as a transparent layer having optical functions including ultraviolet cutoff (UV-cut) (e.g., cuts off or blocks ultraviolet wavelengths) and/or anti-reflection. A material of the first transparent cover layer 110 may be polymer, such as polycarbonate.

The second transparent cover layer 120 is disposed over the surface 112 of the first transparent cover layer 110. Similarly, the second transparent cover layer 120 is a plane that is pervious to light and has certain structure ductility. Accordingly, when the optical film layer 100 is used as a cover plate of a display screen, the combination of the first transparent cover layer 110 and the second transparent cover layer 120 can protect the display screen, such that the display screen has an impact resistance property. The second transparent cover layer 120 has surfaces 122 and 124, which are opposite to each other. The surface 124 of the second transparent cover layer 120 faces the surface 112 of the first transparent cover layer 110. The second transparent cover layer 120 may have optical functions, such as UV-cut, anti-reflection, and/or anti-glare. For example, the second transparent cover layer 120 may be a UV-cut layer, an anti-reflection layer, or an anti-glare layer. In some examples, the second transparent cover layer 120 is an anti-glare layer having a UV-cut function. In the example where the second transparent cover layer 120 is the anti-glare layer having the UV-cut function, the surface 122 of the second transparent cover layer 120 may be coated with a UV-cut film, or the second transparent cover layer 120 is mixed with a UV-cut material. A material of the second transparent cover layer 120 may be polymer, such as polyethylene terephthalate (PET) or polymethyl methacrylate.

In the example where the optical film layer 100 is applied in the display screen, the surface 124 of the second transparent cover layer 120 may be divided into a view area 124v and an edge area 124e, in which locations and sizes of the view area 124v and the edge area 124e respectively correspond to those of a view area and a border area of the display screen. The ink layer 130 is disposed on the edge area 124e of the surface 124 of the second transparent cover layer 120 to shade light emitted toward the border area of the display screen. The ink layer 130 may be a single-layered structure, such as a single black ink layer. The ink layer 130 may be a multi-layered stacked structure, such as a stacked structure including two or more ink layers of the same color or a stacked structure including two or more ink layers of different colors. In some examples, as shown in FIG. 1, the ink layer 130 includes a first ink layer 132 and a second ink layer 134. The first ink layer 132 is disposed on the edge area 124e of the surface 124 of the second transparent cover layer 120, and the second ink layer 134 is stacked on the first ink layer 132. The first ink layer 132 and the second ink layer 134 have different colors. For example, the first ink layer 132 is a light color, and the second ink layer 134 is a dark color. The first ink layer 132 may be, for example, a white ink layer, and the second ink layer 134 may be, for example, a black ink layer or a gray ink layer, to ensure a shading effect of the ink layer 130. Thicknesses of the first ink layer 132 and the second ink layer 134 may both be in the micrometers or tens of micrometers, such as about 16 micrometers.

The connection layer 140 is connected between the surface 112 of the first transparent cover layer 110 and the surface 124 of the second transparent cover layer 120 and between the ink layer 130 and the surface 112 of the first transparent cover layer 110 to connect the first transparent cover layer 110 and the second transparent cover layer 120. Thus, the second ink layer 134 of the ink layer 130 is located between the first ink layer 132 and the connection layer 140. For example, the connection layer 140 may be a water gel or a solid optical clear adhesive. In some examples, the water gel is used as the connection layer 140, so the level difference between the edge area 124e and the view area 124v of the surface 124 of the second transparent cover layer 120 caused by the ink layer 130 is overcome more easily and a thickness of the connection layer 140 is reduced, thereby decreasing a thickness of the optical film layer 100. For example, a thickness of the combination of the connection layer 140 that includes the water gel and the ink layer 130 between the first transparent cover layer 110 and the second transparent cover layer 120 may be smaller than about 50 micrometers.

In the example where the connection layer 140 includes the solid optical clear adhesive, choosing a softer material, such as an anti-glare film made from polyethylene terephthalate, as the second transparent cover layer 120 is beneficial to overcome the level difference caused by the ink. For example, a thickness of the combination of the connection layer 140 that includes the solid optical clear adhesive and the ink layer 130 between the first transparent cover layer 110 and the second transparent cover layer 120 may be about 50 micrometers. In addition, the present embodiment can overcome the ink level difference problem easily, such that the ink layer 130 with a desired color can be coated on the edge area 124e of the surface 124 of the second transparent cover layer 120 according to product designs, thereby diversifying products. Furthermore, process difficulty is eliminated, such that the units per hour per person are increased and production cost is decreased.

The first transparent cover layer 110 or the second transparent cover layer 120 has the UV-cut function, such that a yellowing phenomenon of the display device during outdoor use is prevented. In addition, the connection layer 140 is not limited to a connection material having a UV-cut function, such that there is a wide selection of materials for use in the connection layer 140, thereby reducing the product cost.

Referring to FIG. 2, FIG. 2 is a schematic cross-sectional view of a partial enlargement of the optical film layer 100 in accordance with some embodiments of the present disclosure. In some examples, when the optical film layer 100 is applied in a display screen, a light source 150 may be disposed, for example, directly under the ink layer 130 to provide light in a lateral lit method. The light source 150 of the examples may include light-emitting diodes (LEDs). In some examples, the light source 150 may be disposed directly under the optical film layer 100 to project light toward the optical film layer 100 in a direct lit method. The ink layer 130 is disposed between the surface 112 of the first transparent cover layer 110 and the surface 124 of the second transparent cover layer 120, such that the ink layer 130 is farther from the light source 150 and is closer to eyes 160 of a user (i.e., the ink layer 130 is closer to the light-extracting surface 122 of the optical film layer 100, than that which is disposed on a bottom surface of the optical film layer 100 (i.e. the surface 114 of the first transparent cover layer 110)). Therefore, the ink layer 130 can more effectively shade light 152 emitted by the light source 150 toward the edge area 124e surrounding the view area 124v of the surface 124 of the second transparent cover layer 120, such that an angle θ at which the eyes 160 of the user can see the light emitted toward the edge of the view area 124v from the top of the optical film layer 100 can be greatly reduced. Accordingly, the problem of light leaking from the edge of the view area 124v of the display screen is solved, thereby enhancing an optical property and a displaying effect of the display device.

The optical film layer 100 of the present disclosure can be applied in various display devices. Referring to FIG. 3, FIG. 3 is a schematic diagram of a display device 300 in accordance with some embodiments of the present disclosure. In some examples, the display device 300 includes the optical film layer 100 and a display module 200. The structure and properties of each layer of the optical film layer 100 have been described above and are not repeated herein. The display module 200 is disposed under the surface 114 of the first transparent cover layer 110. For example, the display module 200 may be connected to the surface 114 of the first transparent cover layer 110 of the optical film layer 100 by using a connection layer, such as a solid optical clear adhesive.

In some examples, the display module 200 may include a light source module 210 and a display panel 220. The light source module 210 is disposed at one side of the display panel 220 to provide the display panel 220 with light. As shown in FIG. 3, the light source module 210 is disposed on the back of the display panel 220 and is a backlight module. That is, the display panel 220 is located between the light source module 210 and the optical film layer 100.

The light source module 210 may include, for example, a light-emitting diode light source or an organic light-emitting diode (OLED) light source. In the light-emitting diode light source example, the light source module 210 may be a direct lit light source arrangement or an edge lit light source arrangement. The light source module 210 in the direct lit light source arrangement may further include an optical film sheet, such as a diffusion film sheet or a brightening film sheet, disposed over the light source. The light source module 210 in the edge lit light source arrangement may include a light guide plate disposed directly under the display panel 220 to guide and diffuse laterally incident light to the entire display panel 220. For example, the light source module 210 in the edge lit light source arrangement may further include an optical film sheet, such as a diffusion film sheet or a brightening film sheet, disposed over the light guide plate. In the organic light-emitting diode light source example, the light source module 210 is a direct lit light source arrangement. Where the light source module 210 is the direct lit organic light-emitting diode light source, the light source module 210 similarly may include a diffusion film sheet or a brightening film sheet, disposed over the light source, for example.

The display panel 220 may include, for example, a liquid crystal display module (LCM). The liquid crystal display module may include a liquid crystal (LC) layer and a color filter (CF), in which the color filter is disposed over the liquid crystal layer.

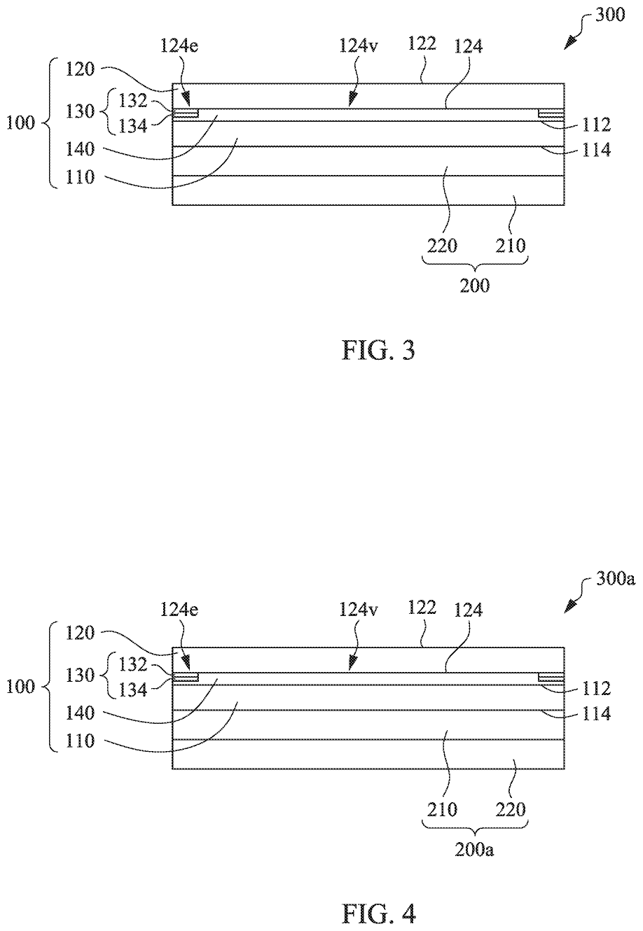

Referring FIG. 4, FIG. 4 is a schematic diagram of a display device 300a in accordance with some embodiments of the present disclosure. A structure of the display device 300a of the present embodiment and the structure of the display device 300 of the aforementioned embodiment are generally the same, but in the display device 300a, a light source module 210 of a display module 200a is disposed over a display panel 220. Thus, the light source module 210 is located between the display panel 220 and the optical film layer 100. The display device 300a is a reflective display device.

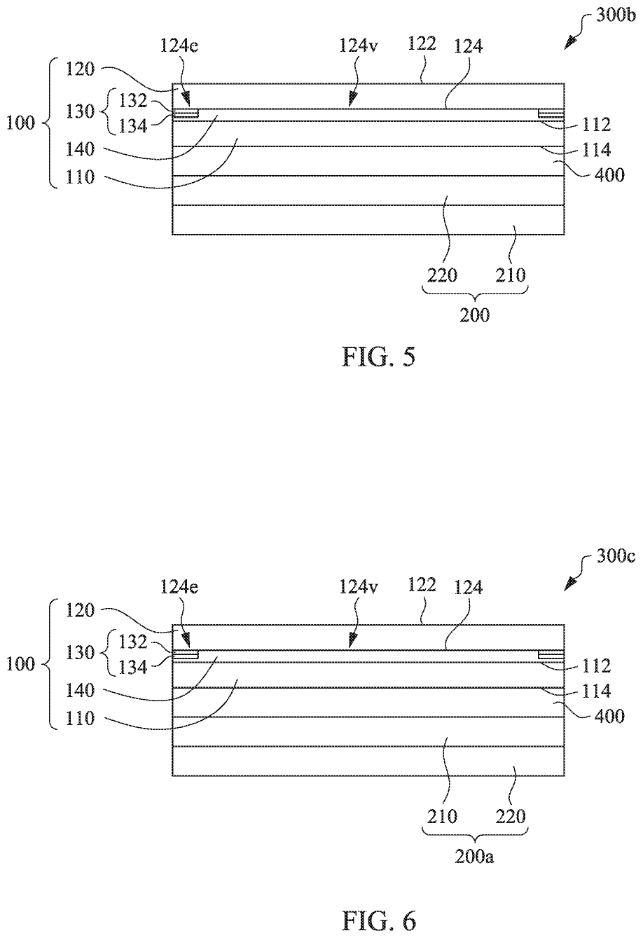

Referring to FIG. 5, FIG. 5 is a schematic diagram of a display device 300b in accordance with some embodiments of the present disclosure. A structure of the display device 300b of the present embodiment and the structure of the display device 300 of the aforementioned embodiment are generally the same, but the display device 300b further includes a touch sensor module 400. The touch sensor module 400 is located between the display panel 220 of the display module 200 and the optical film layer 100. Therefore, the display device 300b is a touch display device having a touch function.

Referring to FIG. 6, FIG. 6 is a schematic diagram of a display device 300c in accordance with some embodiments of the present disclosure. A structure of the display device 300c of the present embodiment and the structure of the display device 300a of the aforementioned embodiment are generally the same, but the display device 300c further includes a touch sensor module 400. The touch sensor module 400 is located between the light source module 210 of the display module 200a and the optical film layer 100. Therefore, the display device 300c is a reflective touch display device.

In conclusion, the technical schemes of the present disclosure put an ink layer between two transparent cover layers, such that light emitted toward an edge of a view area is firstly absorbed and refracted by the lower transparent cover layer and a connection layer and is shaded by the ink layer before entering the upper transparent cover layer. In addition, the ink layer is closer to a light-extracting surface of an optical film layer, such that the ink layer can shade the light emitted toward the edge of the view area more effectively, and an angle at which a user can see the light emitted toward the edge of the view area from a top of the cover layer can be greatly reduced, thereby solving the problem of light leaking from the edge of the view area and enhancing an optical property and a displaying effect of a display device. Furthermore, a softer and thinner film with a UV resistant and anti-glare property may be used as the upper transparent cover layer, such that a level difference between the view area and an edge area caused by the ink layer can be easily overcome, an overall thickness of the optical film layer can be reduced, production costs can be decreased, and units per hour per person can be increased. The problem of light leaking from the edge of the view area is solved without increasing the thickness of the optical film layer, so the ink layer with a desired color can be applied on an edge area according to a product design.

The foregoing embodiments are illustrative of the present invention rather than limiting of the present invention. It will be apparent that various modifications, equivalent replacements, and variations fall within the scope of the following claims of the present invention without departing from the spirit and principle of the invention.

What is claimed is:

1. An optical film layer, comprising:
a first transparent cover layer;
a second transparent cover layer disposed over the first transparent cover layer;
an ink layer disposed on an edge region of a surface of the second transparent cover layer; and
a connection layer disposed between the ink layer and the first transparent cover layer and between the surface of the second transparent cover layer and the first transparent cover layer to connect the first transparent cover layer and the second transparent cover layer.

2. The optical film layer of claim 1, wherein the first transparent cover layer comprises a polycarbonate layer.

3. The optical film layer of claim 1, wherein the second transparent cover layer comprises an anti-glare layer or a polymethyl methacrylate layer.

4. The optical film layer of claim 1, wherein the second transparent cover layer is an ultraviolet cutoff (UV-cut) layer.

5. The optical film layer of claim 1, wherein the ink layer comprises:
a first ink layer disposed on the surface of the second transparent cover layer; and
a second ink layer disposed between the first ink layer and the connection layer, wherein the second ink layer and the first ink layer have different colors.

6. The optical film layer of claim 1, wherein the connection layer comprises a water gel or a solid optical clear adhesive.

7. A display device, comprising:
an optical film layer comprising:
a first transparent cover layer;
a second transparent cover layer disposed over the first transparent cover layer;
an ink layer disposed on an edge region of a surface of the second transparent cover layer; and
a connection layer disposed between the ink layer and the first transparent cover layer and between the surface of the second transparent cover layer and the first transparent cover layer to connect the first transparent cover layer and the second transparent cover layer; and
a display module disposed under the optical film layer.

8. The display device of claim 7, wherein the display module comprises:
a display panel; and
a light source module disposed at one side of the display panel and configured to provide the display panel with light.

9. The display device of claim 8, wherein the light source module is located between the display panel and the optical film layer.

10. The display device of claim 8, further comprising a touch sensor module located between the light source module and the optical film layer.

11. The display device of claim 7, wherein the first transparent cover layer comprises a polycarbonate layer, and the second transparent cover layer comprises an anti-glare layer or a polymethyl methacrylate layer.

12. The display device of claim 7, wherein the second transparent cover layer is an ultraviolet cutoff (UV-cut) layer.

13. The display device of claim 7, wherein the ink layer comprises:
a first ink layer disposed on the surface of the second transparent cover layer; and
a second ink layer disposed between the first ink layer and the connection layer, wherein the second ink layer and the first ink layer have different colors.

14. The display device of claim 7, wherein the connection layer comprises a water gel or a solid optical clear adhesive.
